(19) United States
(12) Patent Application Publication
(10) Pub. No.: US 2026/0101094 A1
(43) Pub. Date: Apr. 9, 2026

(54) INFORMATION PROCESSING METHOD, INFORMATION PROCESSING APPARATUS, AND STORAGE MEDIUM

(71) Applicant: CANON KABUSHIKI KAISHA, Tokyo (JP)

(72) Inventor: MASANORI FUKADA, Tokyo (JP)

(21) Appl. No.: 19/346,844

(22) Filed: Oct. 1, 2025

(30) Foreign Application Priority Data
Oct. 7, 2024 (JP) 2024-176086

(51) Int. Cl. H04N 21/84; H04N 21/81; H04N 21/835

(52) U.S. Cl. CPC H04N 21/84; H04N 21/8153; H04N 21/835

(57) ABSTRACT

An information processing method. First media data output by a machine learning model is obtained. First description information describing the first media data is generated. Second description information describing information relating to the machine learning model used when outputting the first media data is generated. Association information indicating an association between the first media data, the first description information, and the second description information are generated. A media file storing the first media data, the first description information, the second description information, and the association information are generated.

### BACKGROUND

### Field of the Technology

The present disclosure relates to an information processing method, an information processing apparatus, and a storage medium.

### DESCRIPTION OF THE RELATED ART

With recent developments in AI processing technology, a technology called generative AI has been developed that generates or modifies various types of content by generating a machine learning model via training with various data and providing data to this machine learning model as input.

For example, an image generator AI that generates new images by inputting text information to a model trained with a large amount of images and technology the enables chat simulating a real conversation to be performed by text being input have been developed. Other examples using machine learning model include generating a summary of long strings of text, generating new sentences, and generating a completely new image from a plurality of images. With such technology, an image of a person that does not exist can be generated from a plurality of images, and color images can be generated from black and white images. Furthermore, an image and text can be input in a machine learning model so that the input image can be modified. In addition, various type of content can be generated using generative AI, with more examples including the generation of video, audio, and programming code. Other emerging technology includes being able to generate a rendering result from any chosen viewpoint using a machine learning model trained on the basis of images captured from a plurality of viewpoints. A technology called neural radiance field (NeRF) or Gaussian Splatting enables rendering of an image in a three-dimensional space at any chosen viewpoint from a plurality of two-dimensional images.

Images captured by a normal camera or smartphone and images processed by image analysis services are stored in a storage apparatus such as a memory card. Media data such as images and videos generated by generative AI are stored in a storage apparatus such as a memory card, as with images captured by a camera or smartphone, when stored as media content.

Images are typically encoded to reduce the data size in the storage apparatus. For encoding, many codec standards may be used including JPEG, H.264 (AVC), H.265 (HEVC), H.266 (VVC), AV1, and the like. Another example that can be used in a similar manner for encoding is an NNR or similar codec standard that specifies a large number of parameters and weighting of a neural network machine-trained for use in not only images but multi-media analysis and processing, media coding, data analysis, data generation and modification, and the like as substitutable compression neural network expressions. Compression encoding of three-dimensional data such as point group data and mesh data may also be used in a similar manner.

Since encoded compression data is stored in a file, the normative structure of files including metadata is set. In this structure, the method of associating stored data and metadata structure of a specific format is specified. An example of such a type of specified file format includes ISO base media file format (ISOBMFF, ISO/IEC 14496-12).

ISOBMFF is used for transmission via local storage, a network, or a different bitstream streaming mechanism. ISOBMFF is a well-known flexible, extensible file format that encapsulates and describes encoded time-based or non-time-based media data or bitstreams. This file format has a number of extensions. For example, ISO/IEC 14496-15 specifies an encapsulation tool of a video encoding format of various Network Abstraction Layer (NAL) units base. Examples of such an encoding format are Advanced Video Coding (AVC), Scalable Video Coding (SVC), High Efficiency Video Coding (HEVC), Layered HEVC (L-HEVC), and Versatile Video Coding (VVC).

Another example of file format extension is ISO/IEC 23090-2 that defines Omnidirectional Media Application Format (OMAF). Still other examples of file format extension are ISO/IEC 23090-10 and ISO/IEC 23090-18, which define transmission of Visual Volumetric Video-based Coding (V3C) media data and Geometry-based Point Cloud Compression (G-PCC) media data.

Another example of file format extension is High Efficiency Image File Format (ISO/IEC 23008-12, HEIF). This specifies an encapsulation tool for a still image sequence such as a still image or an HEVC still image into a file.

These file formats are standards developed by the Moving Picture Experts Group (MPEG) to store and share images and image sequences, and define file structures with object orientation.

International Publication No. 2021/204526 describes a method for identifying a region in an image stored in a HEIF file as a region item, making an intra-image region identifiable in association with the stored image, and adding annotation information to the identified intra-image region.

Also, US-2021-0349943 describes a method for storing information used in detection of content elements in an image by AI as metadata in a media file. This can record the result of inference processing for detecting a region in an image using AI technology, making information relating to an inference processing process identifiable. In the methods described in International Publication No. 2021/204526 and US-2021-0349943, a result inferred using AI can be recorded and how it was inferred can be identified. However, there are no hints as to how to treat information relating to the actual generation of media content using AI. In other words, the methods described in International Publication No. 2021/204526 and US-2021-0349943 cannot identify that the data corresponding to the media content in a file is data that has been generated by AI inference processing called generative AI and cannot learn the background of how the media data generated by such an AI was generated. Also, the copyright of such content data cannot be identified, meaning that whether or not use of the media data corresponds to copyright infringement cannot be identified. Also, if a condition used in AI when generating media content can be identified, the media content can be re-generated changing the condition. However, such a condition can also not be identified.

### SUMMARY

According to an embodiment of the present disclosure, an information processing apparatus is provided that can identify that media data stored in a media file is content generated or modified by AI.

According to one embodiment of the present disclosure, an information processing method comprises: obtaining first media data output by a machine learning model; generating first description information describing the first media data; generating second description information describing information relating to the machine learning model used when outputting the first media data; generating association information indicating an association between the first media data, the first description information, and the second description information; and generating a media file storing the first media data, the first description information, the second description information, and the association information.

According to another embodiment of the present disclosure, an information processing method, comprises: obtaining a media file storing first media data output by a machine learning model, first description information describing the first media data, second description information describing information relating to the machine learning model used when outputting the first media data, and association information indicating an association between the first media data, the first description information, and the second description information; and executing reproduction processing of the first media data based on the media file.

According to still another embodiment of the present disclosure, an information processing apparatus comprises: a first obtaining unit configured to obtain first media data output by a machine learning model; a first generating unit configured to generate first description information describing the first media data; a second generating unit configured to generate second description information describing information relating to the machine learning model used when outputting the first media data; a third generating unit configured to generate association information indicating an association between the first media data, the first description information, and the second description information; and a fourth generating unit configured to generate a media file storing the first media data, the first description information, the second description information, and the association information.

According to yet another embodiment of the present disclosure, an information processing apparatus comprises: an obtaining unit configured to obtain a media file storing first media data output by a machine learning model, first description information describing the first media data, second description information describing information relating to the machine learning model used when outputting the first media data, and association information indicating an association between the first media data, the first description information, and the second description information; and an executing unit configured to execute reproduction processing of the first media data based on the media file.

Further features of the present disclosure will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a block diagram illustrating an example of the hardware configuration of a storage apparatus.

FIG. 2 is a diagram for describing the file structure of a HEIF file.

FIG. 3 is a diagram for describing the structure of AIGenerationInformationProperty.

FIG. 4 is a diagram for describing the structure of EntityToGroupBox.

FIG. 5 is a diagram for describing the structure of CopyrightProperty.

FIG. 6 is a diagram for describing the structure of UUIDBox.

FIG. 7 is a diagram for describing the structure of UUIDPropertyCopyrightProperty.

FIG. 8 is a flowchart illustrating an example of media file generation processing by the storage apparatus.

FIG. 9 is a flowchart illustrating an example of media file reproduction processing by the storage apparatus or the like.

FIG. 10 is a diagram for describing the structure of DeepLearningInformationEntityGroupBox.

FIG. 11 is a diagram for describing the structure of AIGenerationInformationEntityGroupBox.

FIGS. 12A-12C are diagrams illustrating an example of the configuration of a media file generated by the storage apparatus.

FIGS. 13A-13C are diagrams illustrating another example of the configuration of a media file generated by the storage apparatus.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

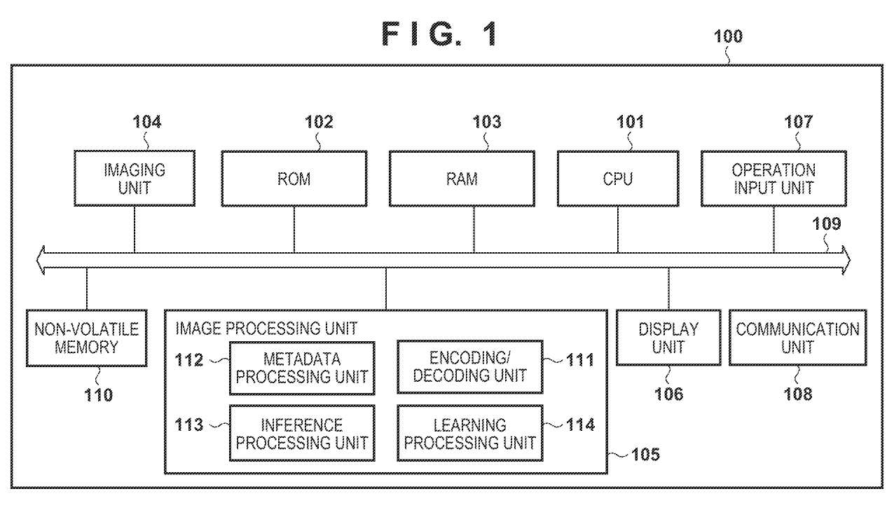

An information processing apparatus according to the present embodiment obtains media data output by a machine learning model and generates first description information (metadata) describing the media data. Next, the information processing apparatus generates second metadata describing information relating to the machine learning model used when outputting the media data. Also, the information processing apparatus generates association information indicating the association between the media data, the first metadata, and the second metadata and generates a media file storing the data and the association information. Such an information processing apparatus will be described below with reference to FIGS. 1 to 13.

First, an example of the hardware configuration of a media file storage apparatus 100 (hereinafter simply referred to as storage apparatus 100) that functions as an information processing apparatus will be described using the block diagram of FIG. 1. As illustrated in FIG. 1, the functional units of the storage apparatus 100 are connected to one another in a communication-enabling manner via a system bus 109. Note that in the present embodiment described herein, each functional unit illustrated in FIG. 1 is implemented via hardware. However, the storage apparatus 100 may be configured with a portion or all of the functional units implemented via software (computer program). In this case, the computer program is executed by a CPU 101, resulting in functions corresponding to each functional unit being implemented.

The CPU 101 executes various types of processing using computer programs and data stored in a RAM 103 and a ROM 102. In this manner, the CPU 101 performs operation control of the entire storage apparatus 100 and executes and controls the various types of processing described as being executed by the storage apparatus 100.

The ROM 102 is an example of a non-volatile storage apparatus capable of permanent information storage. The ROM 102 stores settings data of the storage apparatus 100, computer programs and data relating to startup of the storage apparatus 100, and computer programs and data relating to basic operation of the storage apparatus 100, and the like. The data stored in the ROM 102 includes parameters required for the operations of each functional unit, data for display, and the like.

The RAM 103 is an example of a volatile storage apparatus capable of temporary information storage. The RAM 103 includes an area for storing computer programs and data loaded from the ROM 102 or a non-volatile memory 110 and an area for storing captured images input from an imaging unit 104. Also, the RAM 103 includes an area used when an image processing unit 105 executes the various types of processing, an area for storing data received by a communication unit 108 from the outside, and a working area used when the CPU 101 executes the various types of processing. The RAM 103 of such a configuration can provide various areas as appropriate.

For example, the RAM 103 is also used as a storage area (output buffer) for temporarily storing data and the like output in the operations of the various functional units, instead of just being used as a loading area for computer programs.

The imaging unit 104 performs photoelectric conversion of an optical image formed on an imaging plane of an image sensor (for example, an image sensor such as a CMOS sensor or a CCD) via an optical system (not illustrated) and executes various types of image processing on the analog signals obtained via the photoelectric conversion. Also, the imaging unit 104 performs A/D conversion of the analog signals obtained via the various types of image processing, converts the analog signals into digital signals, and outputs the digital signals as captured images.

The image processing unit 105 executes various types of image processing on images. The image processing according to the present embodiment includes, for example, gamma conversion, color space conversion, white balance processing, exposure correction and similar processing relating to development. Also, the image processing unit 105 may also be capable of executing image analysis processing or combining processing for combining two or more images.

The image processing unit 105 includes an encoding/decoding unit 111, a metadata processing unit 112, an inference processing unit 113, and a learning processing unit 114. To facilitate understanding, in the present embodiment, the processing by the functional units (the encoding/decoding unit 111, the metadata processing unit 112, the inference processing unit 113, and the learning processing unit 114) is described as being executed by hardware corresponding to one image processing unit 105. However, the processing by the functional units may be executed by a plurality of pieces of hardware, and as long as similar functions can be executed, the configuration is not limited.

The encoding/decoding unit 111 is a codec for moving images and still images compliant with H.265 (HEVC), H.264 (AVC), H.266 (VVC), AV1, JPEG, or the like. The encoding/decoding unit 111 executes encoding or decoding of images (still images or moving images (video sequence) handled by the storage apparatus 100. Also, the encoding/decoding unit 111 may execute encoding or decoding of data including parameters and weighting for the machine learning model generated by the learning processing unit 114 and media data such as audio data and the like. Hereinafter, the machine learning model may be referred to as “AI”. Furthermore, the encoding/decoding unit 111 may execute encoding or decoding of three-dimensional data such as point group data, mesh data, and Gaussian splatting data.

The metadata processing unit 112 obtains data (encoded data) encoded by the encoding/decoding unit 111. Also, the metadata processing unit 112 generates a media file compliant with a predetermined file format (for example, HEIF) that includes the encoded data and metadata relating to the encoded data. Hereinafter, a HEIF file compliant with ISOMBFF specifications is described as being used for the media file. However, the media file is not particularly limited as long as it can store similar information. Specifically, the metadata processing unit 112 executes analysis processing of the encoded data stored in image files such as still images and video sequences, generates information relating to still images or video sequences, and obtains parameters relating to encoded data. Also, the metadata processing unit 112 executes processing to store this information as metadata in an image file together with encoded data. Note that the metadata processing unit 112 can generate an image file compliant with not only HEIF but also other video file formats specified by MPEG or other formats such as JPEG. Note that the obtained encoded data may be data pre-stored in the ROM 102 or the non-volatile memory 110 or data stored in the RAM 103 obtained via the communication unit 108. Also, the metadata processing unit 112 generates and stores media data generated or modified by the inference processing unit 113 and metadata input to the machine learning model when generating or modifying media data. Hereinafter, generating media data via a machine learning model and generating media data as a result of modifying media data via a machine learning model may be described collectively without distinction via the expression “generate or modify media data”.

Also, the metadata processing unit 112 generates and stores data resulting from various inference results using a machine learning model and related metadata. For example, the metadata processing unit 112 generates and stores data resulting from recognition of a region in an image obtained via image analysis and metadata indicating such data. Furthermore, the metadata processing unit 112 generates and stores input data used in training the learning processing unit 114 and metadata relating to algorithms used in training. Also, the metadata processing unit 112 analyzes the metadata stored in image files and executes metadata processing when reproducing still images and video sequences.

The inference processing unit 113 executes inference processing on the input data using a learning model generated by the learning processing unit 114 or a learning model trained by an external apparatus or the like. As the input data for the inference processing, input data in accordance with the learning model being used is used. For example, in a case where the inference processing unit 113 uses a learning model that detects a region in an image, an image is input as input data to the learning model and, as a result, a person in the image can be detected or a subject region can be detected. Data for identifying the object or region detected as a result is generated and stored by the metadata processing unit 112. Also, in a case where the inference processing unit 113 uses a learning model that generates an image with text data as an input, text data is input to the learning model and an image corresponding to the inference result can be generated. Also, in a case where the inference processing unit 113 uses a learning model called NeRF that can reconstruct 3D scenes, by inputting coordinates and a line-of-sight angle as input data to the learning model, the position, transparency, and color in a 3D space can be inferred, and a rendering image from the viewpoint can be generated using the inferred information. By converting this into image data, image generation and storage may be performed.

Also, the inference processing unit 113 can execute inference processing from various learning models and input data in accordance with such learning models to execute various types of inference processing relating to media data. Here, in inference processing, the inference processing unit 113 can use various learning models used in conjunction with the development of AI technology. For example, the inference processing unit 113 can use a learning model that performs various types of output including generating text by summarizing a large amount of text data, generating audio data from text data, generating color image data from monochrome image data, and the like. Note that information input as input data may be pre-obtained data or may be information designated by the user via operation of an operation input unit 107. The inference processing executed by the inference processing unit 113 may be processing for detection such as recognizing an object from an image stored in an image file or the like or may be generation processing for generating and modifying an image that itself is stored in an image file. Such processing may be caused to be executed by an external apparatus or external service that can communicate with the storage apparatus 100 via the communication unit 108, for example. In such a case, the storage apparatus 100 obtains the data of the inference result including a detection result of a subject object, generated images, and the like from the external apparatus. Note that the inference processing executed by the inference processing unit 113 may be executed by a single learning model or executed via various processing from a combination of learning models.

The learning processing unit 114 executes learning processing called machine learning using a data set that corresponds to the learning target. As the data set corresponding to the learning target, image data obtained from the imaging unit 104, data obtained from an external apparatus that can communicate with the storage apparatus 100 via the communication unit 108, information designated by the user via operation of the operation input unit 107, and the like can be used. Also, the algorithm used in learning may be based on a program pre-stored in the ROM 102 of the storage apparatus 100, based on program data obtained from an external apparatus that can communicate with the storage apparatus 100 via the communication unit 108, or based on information designated by the user via operation of the operation input unit 107.

Also, the learning processing described as being executed by the learning processing unit 114 may be caused to be executed by an external apparatus or external service that can communicate with the storage apparatus 100 via the communication unit 108, for example. In such a case, the storage apparatus 100 may obtain trained model data from the external apparatus or may store this result in an external apparatus and obtain it as information that can be referenced. Also, the algorithm used in learning is not limited to one, and learning based on various algorithms may be performed using the same training data.

The display unit 106 is a display apparatus including a liquid crystal display (LCD), a touch panel screen, or the like. The display unit 106 may be a display apparatus detachably connected to the storage apparatus 100 or a display apparatus integrally formed with the storage apparatus 100, for example. The display unit 106 executes various types of display processing including display (live view display) of images (still images or video) currently being captured by the imaging unit 104, display of information or a graphical user interface (GUI) relating to various types of settings, and the like. Also, the display unit 106 performs image display when a generated image file is reproduced. Furthermore, the display unit 106 may display data generated or analyzed by the metadata processing unit 112 together with an image as identifiable information.

The operation input unit 107 is a user interface such as an operation button, a switch, a mouse, a keyboard, or the like that can input various types of instructions to the CPU 101 by receiving a user operation. Note that in a mode in which the display unit 106 is a touch panel screen, the operation input unit 107 may include a touch panel sensor.

The communication unit 108 is a communication interface for data communications with an external apparatus. The communication unit 108, for example, may be a network interface for connecting to the network and transmitting and receiving transmission frames. In this case, the communication unit 108, for example, may be a PHY and MAC (transmitting media control processing) capable of a wired LAN connection via the Ethernet (registered trademark). Also, in a case in which the communication unit 108 is capable of connecting to a wireless LAN, the communication unit 108 may include a controller, an RF circuit, and an antenna for performing wireless LAN control based on IEEE 802.11a/b/g/n/ac/ax or the like.

The non-volatile memory 110, for example, is a non-volatile information storage apparatus with a large storage capacity such as an SD card, CompactFlash (registered trademark), flash memory, and the like. For example, the non-volatile memory 110 may store generated image files according to the present embodiment or may store image files obtained from an external apparatus via the communication unit 108.

Note that the hardware configuration illustrated in FIG. 1 is merely an example of a configuration that can implement the operations of the storage apparatus 100 described below and may be changed or modified as appropriate. For example, the imaging unit 104 in FIG. 1 is integrally formed with the storage apparatus 100, but it may be detachably connected to the storage apparatus 100. Also, the image processing unit 105 may be an apparatus detachably attached to the storage apparatus 100 or may be an external apparatus that can communicate with the storage apparatus 100 via the communication unit 108.

Next, the generation of image files by the storage apparatus 100 will be described. An image file generated by the storage apparatus 100 can store a plurality of images and can include information attached to the stored images. In the modes described hereinafter, HEIF is used as the file format of the image file, and, to generate an image file (HEIF file) compliant with HEIF, the required information is derived and attached to metadata which is generated and stored. However, the file format of the media file used in the present embodiment is not limited thereto and may be a different video file format specified by MPEG, an omnidirectional media application file format, a file format that handles 3D data such as point group data, JPEG, or the like. Also, the media file according to the present embodiment is not limited to being an image file, and any form may be used as long as it is a media file that can store information relating to media data generated by AI processing. For example, a text data file or a media file such as an audio data file may be used.

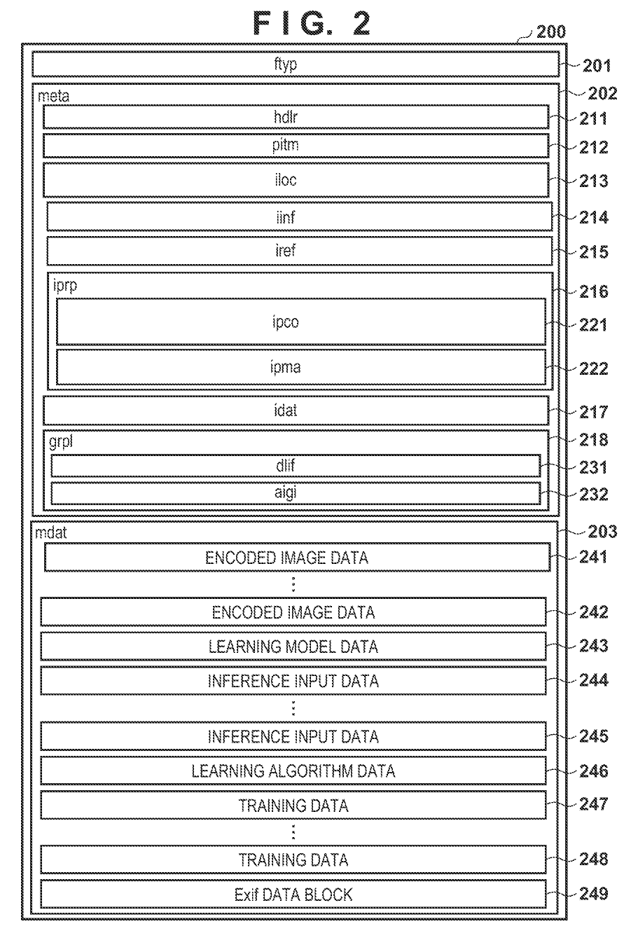

Next, the file structure of a HEIF file will be described below using FIG. 2. As illustrated in FIG. 2, a HEIF file 200 generally includes the three boxes (storage areas) described below.

A first box 201 is a FileTypeBox (ftyp). The box 201 stores a brand name for a reader of the HEIF file 200 to identify the specifications of the HEIF file 200.

A second box 202 is a MetaBox (meta). As illustrated in FIG. 2, the box 202 stores various types of description information relating to an image in separate boxes. The information stored in the box 202 will be described below.

A third box 203 is a MediaDataBox (mdat). The box 203 stores encoded data (image) 241 to 242 as an encoded bitstream. In the present embodiment, image data is generated by the inference processing unit 113, and encoded data of the image is stored in the box 203 as media data. Note that here, image data is used as the data set for training by the learning processing unit 114 using a learning algorithm, and in the example described below, such image data is stored in the box 203. However, the media data used is not limited to being an image, and in a case where other media data is used for training and generated, a bitstream of media data corresponding to this is stored in the box 203. The bitstream may be data compressed using a compression algorithm. Also, the box 203 may store a bitstream of image data obtained from the imaging unit 104 in a compressed form and may separately store data generated by the inference processing unit 113. In such a case, the box 203 can store region data that can identify the region detected, for example, as the data generated by the inference processing unit 113.

The box 203 stores learning model data 243 generated or obtained by the learning processing unit 114. The learning model data 243 may be a bitstream compressed by a compression algorithm such as NNR or may be uncompressed data that can express parameters, weighting, and the like.

The box 203 stores inference input data 244 to 245 used when the inference processing unit 113 executes inference processing using the learning model data 243. The inference input data 244 to 245 is stored as an encoded bitstream in a case where the media data to be processed is image data or audio data. Also, in a case where the media data is data that can be expressed as text data or metadata, data compressed using a generic compression algorithm may be stored as the inference input data 244 to 245.

The box 203 stores training data 247 to 248 corresponding to the training data set used in machine learning by the learning processing unit 114 and learning algorithm data 246 used in learning. The training data 247 to 248 is stored as an encoded bitstream in a case where the media data to be processed is image data or audio data. Also, in a case where the media data is data that can be expressed as text data or metadata, data compressed using a generic compression algorithm may be stored as the training data 247 to 248. The learning algorithm data 246, for example, may be identification information that can reference the learning algorithm, programming code data, or precompiled execution program.

Also, the box 203 stores an Exif data block 249 including information of at the time of image capture by the imaging unit 104 and the like. A mode in which the box 203 is used as an area for storing the encoded data 241 to 242, the learning model data 243, the inference input data 244 to 245, the training data 247 to 248, the learning algorithm data 246, and the Exif data block 249 has been described using the example in FIG. 2. However, as the area storing this data, instead of the box 203, a box structure such as “idat” or “imda” may be used, for example. Note that hereinafter, the encoded data 241 to 242 and sometimes the training data 247 to 248 and the inference input data 244 to 245 stored in the box 203 may be referred to by a different term such as “image” or “encoded data” as appropriate.

Note that in a case where video or audio, a video sequence, timed metadata, timed text data, or the like are stored as media data, these may be separately stored in MovieBox (moov) (not illustrated). In this box, metadata for describing various types of information relating to the presentation including video, audio, and the like stored in the image file can be stored. Note that in a case where the stored data is a video sequence, metadata is stored using a mechanism for describing the various types of information relating to the video. However, time-limited information other than video is optional information.

A box 211 is HandlerReferenceBox (hdlr) that stores a declaration of the handler type for analyzing the structure of the box 202. In the HEIF file 200 generated in the storage apparatus 100 according to the present embodiment, metadata describing untimed data stored in the box 202 is set with still images as the target. Thus, a handler type name “pict” for identifying still images as the target is set in the box 211.

A box 212 is a PrimaryItemBox (pitm) that specifies an identifier (item ID) of the image data corresponding to a representative item from among the image items to be stored by the HEIF file 200. In the present embodiment, reproduction display is performed with the image item designated as the first priority item in the box 212 as the image to be normally displayed.

A box 213 is an ItemLocationBox (iloc) that stores information indicating the storage place of each information item in the HEIF file 200 starting with image items. The box 213 representatively describes the storage place of the image item as a byte offset from the head of the HEIF file 200 or a data length from the head. In other words, the box 213 can store information for identifying the location of the encoded data to be stored in the box 203, the learning model data, the inference input data, the learning algorithm data, and the Exif data block. Also, for derived items, it is displayed in the box 203 that no data exists on the basis of the information stored in the box 213. In a case where data does not exist in the box 203, a box data structure does not exist in the box 203 or data of a derived item is stored in a box 217 in the box 202.

A box 214 is ItemInfoBox (iinf). The box 214 stores information that defines the basic information (item information), such as item ID, item type indicating item category, and the like, for all of the items included in the HEIF file 200. As item information, not only image items such as encoded image items and derived image items, but also items such as learning model items, inference input items, learning algorithm items, Exif information items indicating Exif data block, and similar items indicating data relating to the AI processing are designated. Note that it is sufficient that the inference input data stored in the box 214 is information designating an item according to the data type, and for image data for example, the data may be information defining it as an image item. Information defining text data as a text item and information defining metadata as a metadata item may also be stored in the box 214. Also, the information relating to learning model items may be stored in the box 214 as deductive information items of an item type URI specified for the purpose of detecting content factors.

A box 215 is an ItemReferenceBox (iref) that stores information (association information) describing the association between items included in the HEIF file 200. In a mode in which the image item is a captured image, the box 215 stores association information describing the association between the image item and an item of that image capture information (Exif data or the like). Also, in a mode in which a plurality of image items are related to a derived image, the box 215 stores association information describing the association between image items. In associating each of the items, the item reference type is designated, and the item reference type can be identified. In the box 215, the reference relationship between each item is described by item IDs designated in the box 214 being described in each from_item_ID and to_item_ID region. Also, the box 215 stores association information describing the association between each item relating to AI processing. Note that the association between items relating to AI processing may be performed via description in the box 215 or via description in an EntityToGroupBox described below, and as long as the method is specified in advance, the description section is not particularly limited.

A box 216 is an ItemPropertiesBox (iprp) that stores various types of property information (item property) of the information items included in the HEIF file 200. More specifically, the box 216 includes an ItemPropertyContainerBox (ipco), which is a box 221 describing the property information, and an ItemPropertyAssociation (ipma), which is a box 222 describing information indicating the association between the property information and each item. The box 221, for example, may store property information, such as entry data indicating the HEVC parameter set required to decode the HEVC image item, entry data indicating, using pixels as the unit, the width and height of the image item, and the like. Here, as an item property, property information that can designate user-unique information may be used.

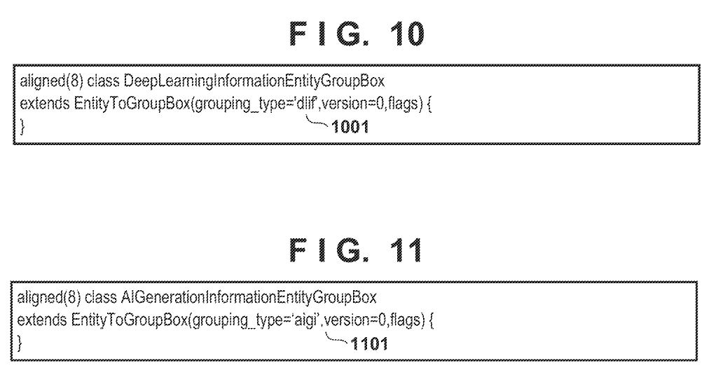

UUIDProperty (uuid) illustrated in FIG. 7 is an example of property information that can store a user-defined property. As user-defined information, for example, vendor-specific information or information specified in a standard such as an independently expanded industry group using a standard specified by MPEG or the like may be used. In the UUIDProperty illustrated in FIG. 7, a four-character code “uuid” indicated in definition 701 is included, and the UUIDProperty is identified using this four-character code. Also, in the UUIDProperty, an extended_type that can identify the user-unique extension type indicated in definition 702 is included. Designating a 16-byte code designated in the extension type may be performed via a method specified in IETF RFC4122 and ISO/IEC 9834-8. The four-character code of the definition 701 and the user-defined property identified by an extension type of the definition 702 can include property information that can be freely designated by a user in a field 703. The property information stored as a uuid property can be associated with an item or an entity group in a similar manner as with other property definitions. Note that since the uuid property is user-defined property information, the property information designated here is normally ignored by a file processing apparatus that cannot identify the designated extension type.

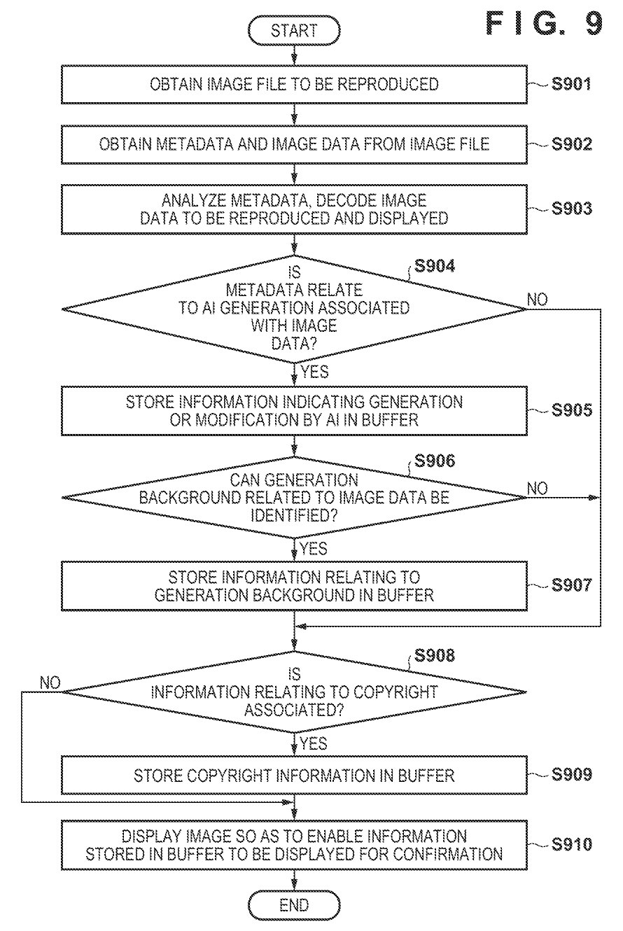

The UUIDProperty illustrated in FIG. 7 is stored in a file as property information that can be directly associated with an item or an entity group. The UUIDBox illustrated in FIG. 6 is an example of user-defined metadata that can be stored in any metadata hierarchy. As user-defined information in the UUIDBox, as in the UUIDProperty for example, vendor-unique information or information specified in a standard such as an independently expanded industry group using a standard specified by MPEG or the like may be used. In the UUIDBox illustrated in FIG. 6, a four-character code “uuid” indicated in definition 601 is included, and the UUIDBox is identified using this four-character code. Also, in the UUIDBox, an extended_type that can identify the user-unique extension type indicated in definition 602 is included. Designating a 16-byte code designated in the extension type may be performed via a method specified in IETF RFC4122 and ISO/IEC 9834-8. The four-character code of the definition 601 and the user-defined metadata identified by an extension type of the definition 602 can include metadata that can be freely designated by a user in a field 603. Note that since the uuid box is user-defined metadata, the property information designated here is normally ignored by a file processing apparatus that cannot identify the designated extension type. Note that since the UUIDBox is different from the UUIDProperty in that it is designatable in any Box hierarchy, user-unique definition including the application range is possible. However, the UUIDProperty is different from the UUIDBox in that it is designatable as information closed to property association.

As the definition of metadata using the uuid box, information independently defining application-unique metadata can be stored in a file. As a standard for embedding editting content or information relating to rights in digital data such as images and videos, the C2PA standard established as a standard by the Content Authenticity Initiative (CAI), which is a group promoting certification of the authenticity of content may be used. In this standard also, the uuid box may be applied as a definition for storing metadata specified as C2PA in an MPEG-specified media file.

Also, as property information that can be designated as an item property, TransformativeProperty intended for display when an image is converted when the image is to be output may be stored. TransformativeProperty may be used for storing data indicating rotation information for displaying a rotated image, data and the like displaying cropping information for displaying a cropped image, and the like, for example.

Next, the box 222 (ipma) uses the ID (item ID) of the information item to store entry data indicating the association with the property information stored in the box 221 for each item. Note that for items with no property information associated to other items, such as an Exif information item, entry data indicating the association is not stored.

The box 217 is ItemDataBox (idat) that stores data relating to the items included in the HEIF file 200. The box 217 stores a data structure for describing derived image items, for example. Here, for example, for items with the item type “grid” indicated in the box 214, the data structure of a grid-derived image item defining an input image reconstructed in a predetermined grid order is designated in the box 217. For an input image of a derived image item, the box 215 is used to designate an item reference of a dimg reference type. Note that in a case where the derived item does not have a data structure, for example, for an identity derived image item “iden”, no data structure is stored in the box 217.

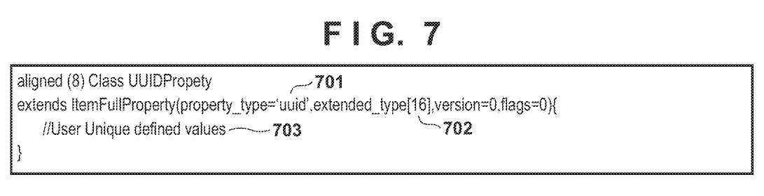

A box 218 is a GroupListBox (grpl). The box 218 stores metadata for grouping and storing entities such as items and tracks included in the HEIF file 200. The box 218 stores a box that extends and defines EntityToGroupBox illustrated in FIG. 4 for each grouping type parameter. A grouping_type indicated in definition 401 is included in EntityToGroupBox. A four-character code defined per grouping type is included in grouping_type, and the grouping type of EntityToGroupBox is identified using the four-character code. Grouping type is a concept for specifying the relationship of a plurality of entities included in a group. The EntityToGroupBox includes group_id 402 for uniquely identifying the entity group itself and num_entities_in_group 403 indicating the number of entities included in the entity group. Also, the EntityToGroupBox includes entity_id 404 of a number designated in num_entities_in_group. In the entity_id 404, an item ID identifying the item defined in the box 214 or a track ID identifying a single track of a presentation included in MovieBox (not illustrated) can be designated. Also, in the entity group of a specified group type, a group_id identifying another entity group can be designated. Also, the EntityToGroupBox has a configuration which can be extended and defined for each grouping type and is used as a structure capable of defining an extension parameter in accordance with the grouping type in a portion 405. In this manner, by the grouping type being identified in EntityToGroupBox, entities such as a plurality of image items or tracks included in a group can be handled as a meaningful group unit.

In the box configuration illustrated in FIG. 2, a box 231 obtained by extending EntityToGroupBox to a grouping type “dlif(DeepLearningInformationEntityGroupBox)” that is one of grouping types for grouping information using machine learning processing is stored. Also, a box 232 obtained by extending EntityToGroupBox to a grouping type “aigi(AIGenerationInformationEntityGroupBox)” that is one of grouping types for grouping information using media data generation and modification processing using machine learning model is stored.

The box 231 is a box for extending and defining EntityToGroupBox as described above. Here, each definition 402 to 404 included in EntityToGroupBox is included in the box 231, and “dlif” is included in grouping_type 401 as a four-character code (4CC) identifying DeepLearningInformationEntityGroupBox.

Also, in entity_id, an item ID indicating the learning model to be generated as a training result, an item ID indicating the learning algorithm, and an item ID indicating training data corresponding to a training data set are designated, and information relating to a sequence of machine learning processing can be identified by these designations. Note that in entity_id, a group ID of “dlif” entity group obtained by grouping information of machine learning processing separately stored can be designated. Accordingly, information relating to difference training can be identified as a group.

The box 232 is a box for extending and defining EntityToGroupBox as described above. Here, each definition 402 to 404 included in EntityToGroupBox is included in the box 232, and “aigi” is included in grouping_type 401 as a four-character code (4CC) identifying AIGenerationInformationEntityGroupBox.

Also, in entity_id, an item ID indicating media data such as images generated as a result of generation using inference, an item ID indicating a learning model used in inference processing when generating media data, and an item ID indicating inference input data correspond to an input data set used in inference are designated, and information relating to a sequence of inference processing for generating and modifying media data can be identified by these designations. Note that as the item ID indicating the learning model, an item ID indicating a learning model generated as a result of training designated in the “dlif” entity group described above may be designated. Note that a detailed definition of the “dlif” entity group and the “aigi” entity group will be described below.

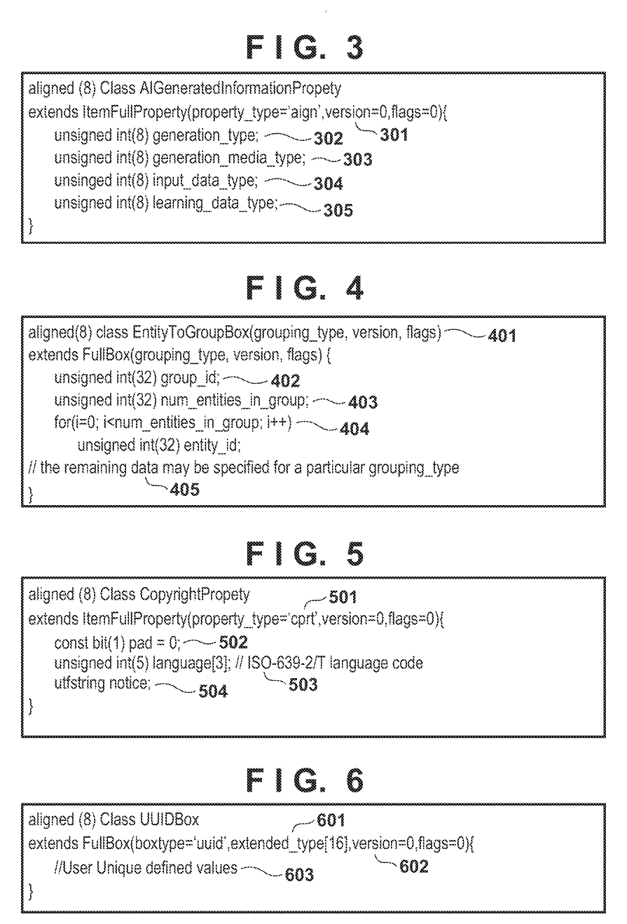

Next, a definition for an item property that can identify whether or not media data is media data generated by AI that can be stored in the HEIF file 200. FIG. 3 is a diagram illustrating the data structure of AIGeneratedInformationProperty, which is an item property that can be stored in the box 221 of the HEIF file 200. This AIGeneratedInformationProperty is an ItemFullProperty extension and includes property_type 301 (aign). Also, AIGeneratedInformationProperty includes parameter generation_type 302, generation_media_type 303, input_data_type 304, and learning_data_type 305. Note that, as with the UUIDProperty and the UUIDBox, the definition described as being described in the AIGeneratedInformationProperty may be configured so that definition is performed as an AIGeneratedInformationBox and not a definition via property. In this case, the definition for media data with time-limited information such as videos and audio, for example, can be stored as a box of an option designated as a SampleEntry in a SampleDescriptionBox designating a configuration relating to a sample in a TrackBox (trak) included in MovieBox (moov) (not illustrated).

Such an AIGeneratedInformationProperty may be defined as follows. AIGeneratedInformationProperty is a descriptive item property identified by the property_type 301 (aign). The AIGeneratedInformationProperty identifies that media data corresponding to an associated item is content generated or modified using AI. The generation_type 302 is an integer with no sign for identifying the type of content generated or modified using AI. Here, a value of 0 means undefined. Note that in the generation_type 302, a value of 0 may be designated if the type of content is unclear. Here, a value of 1 indicates that the media data is media data generated by AI, and a value of 2 indicates that the media data is media data partially modified by AI. Also, a value of 3 indicates that the media data is media data on which processing using AI has been executed. The values of 4 onward are reserved.

A case where a value of 1 is allocated indicates that the media data is a (new) image generated on the basis of text information, a (new) document generated on the basis of an image, or the like. A case where a value of 2 is allocated indicates that the media data is (partially non-existing) content obtained by partial modification such as a fake image or the like. A case where a value of 3 is allocated indicates that the media data is media data obtained by correcting (refined via correction processing using AI including accuracy enhancement, noise removal, or the like) the original media data.

The generation_media_type 303 is an integer with no sign for identifying the media data type of the item associated with the present property. As the media type designated in the present parameter, information similar to the information designated as content type in an item defined as an entry of ItemInformationBox should be designated. Also, in a case where time-limited media data is used, information similar to the media data type designated as a media handler should be designated in the generation_media_type 303. Here, a media data box value of 0 indicates undefined. Note that in the generation_media_type 303, a value of 0 may be designated if the media type is unclear. Here, a value of 1 indicates that the media data is a still image, and a value of 2 indicates that the media data is a video. A value of 3 indicates that the media data is audio, and a value of 4 indicates that the media data is text data. Also, value of 5 indicates that the media data is metadata, a value of 6 indicates that the media data is 3D still image data, and a value of 7 indicates that the media data is 3D video data. The values of 8 onward are reserved.

The input_data_type 304 is information identifying the type of the data input when generating or modifying the media data associated with the present property. The value that can be defined in the present parameter is similar to the value defined in the generation_media_type 303. Note that in the case of executing inference processing using input data including a plurality of data types, the present parameter may include a number of parameters numbering the types. In such a case, the generation_media_type 303 is required to have a data structure where a plurality of parameters can be designated. Also, in a case where the input data is associated, information matches the media type of the associated data should be designated.

The learning_data_type 305 is a value that can identify what type of data was used to train the learning model for generating or modifying the media data associated with the present property that was used to perform generation or modification to obtain the media data. The value that can be defined in the present parameter is similar to the value defined in the generation_media_type 303. Note that for a model trained using data including a plurality of data types, the present parameter may have a configuration in which a number of parameters numbering the types can be designated. In such a case, the learning_data_type 305 is required to have a data structure where a plurality of parameters can be designated.

Note that in the present embodiment, since identification of whether the item has been generated or modified by AI is performed, such information is stored in a property that can be associated with the item. However, the identification may be performed by associating information that can identify whether the item has been generated or modified by AI with the item (not using a property). A method for performing association will be described separately below in detail. Note that by performing such association using a property, whether or not the item has been generated or modified by AI can be easily identified by only confirming the property associated with the item. Note that the AIGeneratedInformationProperty described in the present embodiment is merely an example, and it is not necessary for all of the parameters described above to be included, and additional parameter may be further included. Also, similar information may be described in a manner to be identifiable by different descriptions using different 4CCs.

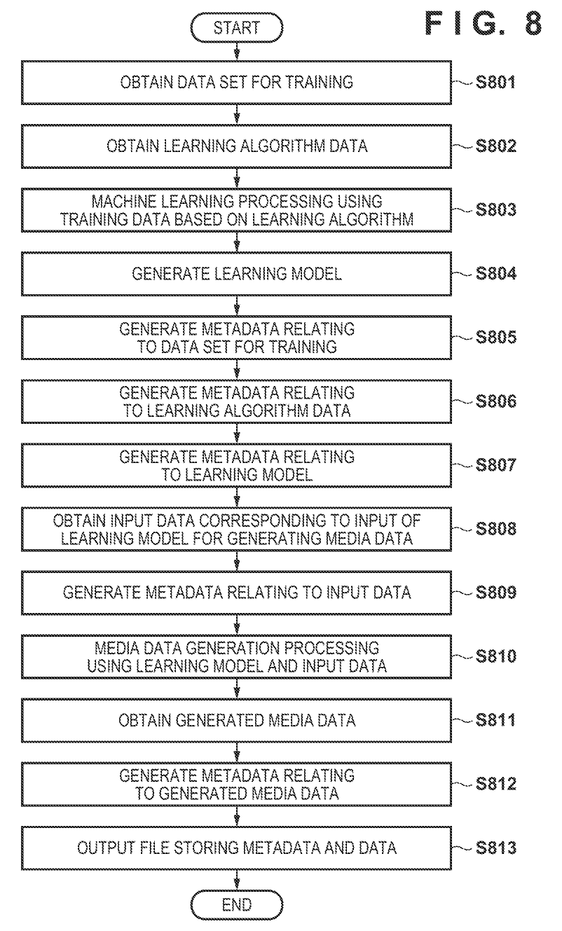

Next, a definition for an item property that can identify information relating to copyright of media data that can be stored in the HEIF file 200 will be described. FIG. 5 is a diagram illustrating an example of a data structure of CopyrightProperty, which is an item property that can be stored in the box 221 of the HEIF file 200. The CopyrightProperty is an ItemFullProperty extension and includes property_type 501 (cprt). Also, the CopyrightProperty includes parameter pad 502, language 503, and notice 504. The CopyrightProperty according to the present embodiment is a definition in which CopyrightBox specified in ISO/IEC 14496-12 (ISOBMFF) is treated as a property.

Such a CopyrightProperty may be defined as follows. The CopyrightProperty is a descriptive item property identified by the property_type 501. The CopyrightProperty includes a copyright statement applied to the media data corresponding to the associated item. The copyright statement associated with the media data according to the present embodiment is information (copyright information) relating to the copyright of the media data and includes copyright information of the media data or copyright information of the data used as training data of the machine learning model used when generating or modifying the media data. Here, in some cases, a plurality of CopyrightProperty using different language codes may be associated with the same item. Also, CopyrightProperty with different copyright statements for each item can be associated.

The copyright information stored in association with media data includes information indicating that the media data is copyrighted material, information indicating that copyrighted material is included in the training data of the machine learning model that output the media data, and information indicating that copyrighted material is included in the input data input to the machine learning model when the media data was output. Here, the copyright information may be information indicating the copyright holder of the copyrighted material and the year the copyrighted material was released, may be information indicating only whether or not the associated media data was output via a learning model using copyrighted material as training data, or may be information (for example, a URL or the like) for accessing the copyrighted material. Also, such copyright information may include information indicated via text and may include flag information or the like indicating that the associated media data has been output by a learning model using copyrighted material as training data. The configuration is not particularly limited.

Pad 502 is a parameter of a value that is normally designated as 0 and a 1-bit field included for byte alignment. The language 503 declares the next text language code in a three-character code format as specified in ISO 639-2. Each character is designated as a different between an ASCII value and 0×60. The language code is restricted to three lowercase characters, and thus these values are strictly positive. The notice 504 designates copyright display.

As described in the present embodiment, by defining CopyrightBox as CopyrightProperty, copyright information can be described for each item included in the file. In other words, copyright information for each item, such as a still image, included in one file can be designated.

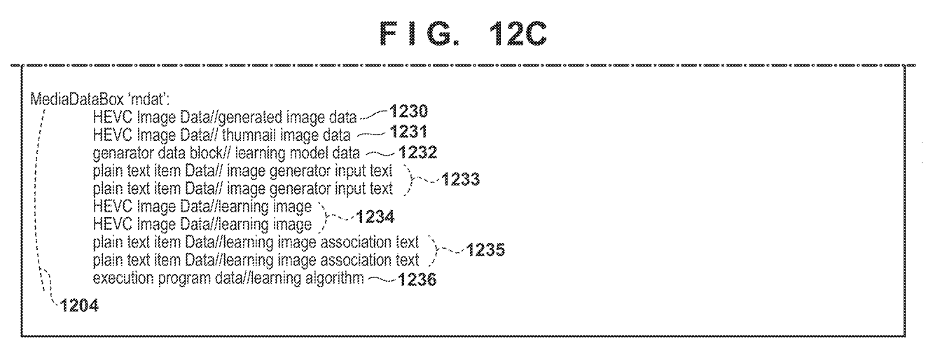

Next, a definition for grouping and identifying information using machine learning processing that can be stored in the HEIF file 200 will be described. FIG. 10 is a diagram illustrating an example of the data structure of DeepLearningInformationEntityGroupBox, which is an entity group for grouping information using machine learning processing that can be stored in the box 218 of the HEIF file. The DeepLearningInformationEntityGroupBox is an EntityToGroupBox extension and includes grouping_type 1001 (dlif). Here, an additional parameter specific to the entity group type is not defined.

Such a DeepLearningInformationEntityGroupBox may be defined as follows. The DeepLearningInformationEntityGroupBox is identified by the grouping_type “dlif”. The DeepLearningInformationEntityGroupBox is a machine learning information group for associating the learning model and the learning algorithm and the training data set. In a case where a unique ID is used in the DeepLearningInformationEntityGroupBox, the machine learning information group can designate the entity group separately grouped as an entity of a machine learning information group. For example, in the DeepLearningInformationEntityGroupBox, an entity group grouping the learning algorithm may be separately defined and the group ID designated, or the entity group grouping the learning model may be separately defined and a plurality of learning models including a learning model based on difference training may be grouped and designated as one learning model group.

The number of entities in a machine learning information group is required to be three or more, and one entity_id value indicates an item or entity group indicating the learning model generated as a result of training. Also, another one of the entity_id values indicates an item or entity group indicating the algorithm information used in training. Another entity_id value indicates an item or track of data corresponding to the data set used in training. Note that in a case where training need to be performed with a plurality of types of data associated, the entity_id value may correspond to the associated data, or association of the data may be performed referencing a separately defined group or item, and the entity_id value may designate only one type of data (in the association). Also, flags may be used to identify that the entity_id value designated as training data is a plurality of sets.

Also, for all of the information relating to the machine learning model, designation via entity_id is not required for an entity included in the machine learning information group. For example, a configuration may be used in which only the learning algorithm information and training data sets are indicated by the entity_id. Also, for example, a configuration may be used in which, after an entity included in the present entity group is made identifiable using flags, information designated in the group switches according to the flags value (for example, according to the flags value, switching between a configuration in which only the learning algorithm information and the training data set are indicated by the entity_id and a configuration in which different data to these are indicated by the entity_id).

Note that for a portion or all of the entities included in the present entity group, association may be performed using item reference. In such a case, by defining the reference type for associating learning algorithm information to a learning model and defining a reference type for associating a training data set to a learning model, the associated entity can be designated. Accordingly, if each item is associated in a similar manner, the location where the association information is described is not particularly limited.

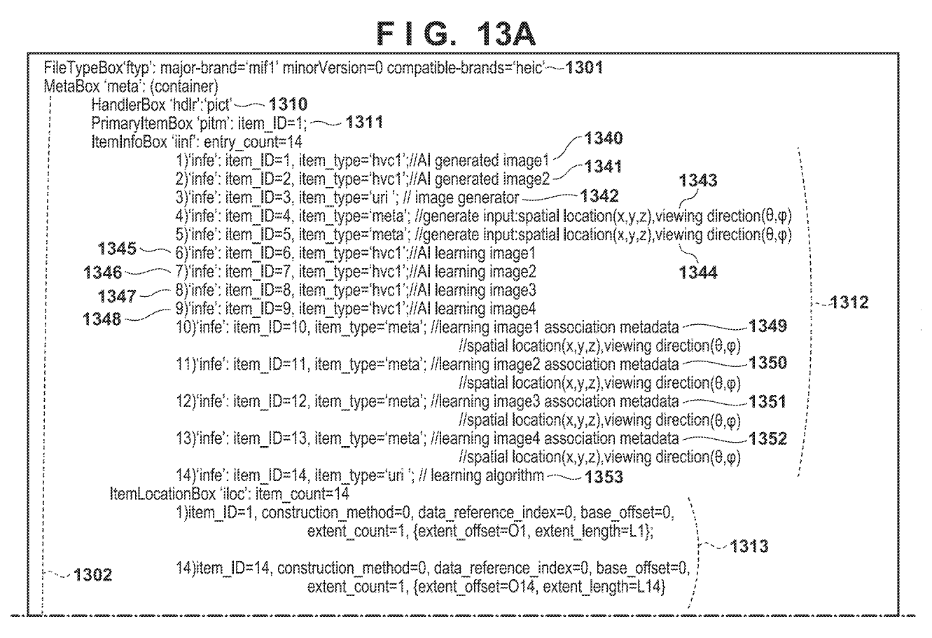

Next, a definition for grouping and identifying information of when the media data is generated or modifying using a learning model that can be stored in the HEIF file 200 will be described. FIG. 11 is a diagram illustrating an example of the data structure of AIGenerationInformationEntityGroupBox, which is an entity group for grouping information of when the media data is generated or modified using a learning model that can be stored in the box 218 of the HEIF file. The AIGenerationInformationEntityGroupBox is an EntityToGroupBox extension and includes grouping_type 1101 (aigi). Here, an additional parameter specific to the entity group type is not defined.

Such a AIGenerationInformationEntityGroupBox may be defined as follows. The AIGenerationInformationEntityGroupBox is identified by the grouping_type “aigi”. The AIGenerationInformationEntityGroupBox is an AI generation/modification information group that stores association information indicating the association between generated or modify media data, the learning model used in the generation or modification, and the input data set used in the generation or modification. Hereinafter, “information of when the media data is generated or modified” refers to information indicating the learning model used in the generation or modification or the input data set used in the generation or modification associated with the generated or modified media data.

In a case where a unique ID is used in the AIGenerationInformationEntityGroupBox, the AI generation/modification information group can designate the entity group separately grouped as an entity of an AI generation/modification information group. For example, in the AIGenerationInformationEntityGroupBox, an entity group grouping the learning model may be separately defined and the group ID designated, and a plurality of learning models including a learning model based on difference training may be grouped and designated as one learning model group.

The number of entities in the AI generation/modification information group is required to be three or more, and one entity_id value indicates an item, track, or entity group indicating the media data generated or modified as a result of inference processing using a learning model. Also, another one of the entity_id values indicates an item or entity group indicating the learning model used in the generation or modification. Another entity_id value indicates an item or track of data corresponding to the input data set used in the inference processing for generation or modification. Note that in a case where the inference processing need to be performed with a plurality of types of input data associated, the entity_id value may correspond to the associated input data, or association of the data may be performed referencing a separately defined group or item, and the entity_id value may designate only one type of data (in the association). Also, flags may be used to identify that the entity_id value designated as input data is a plurality of sets.

Also, for all of the information relating to generation or modification of the media data, designation via entity_id is not required for an entity included in the AI generation/modification information group. For example, a configuration may be used in which, after an entity included in the present entity group is made identifiable using flags, information designated in the group switches according to the flags value (for example, according to the flags value, switching between a configuration in which only the learning model information (information indicating the learning model) and the input data set are indicated by the entity_id and a configuration in which the generated or modified media data and the input data set are indicated by the entity_id).

Note that for a portion or all of the entities included in the present entity group, association may be performed using item reference. In such a case, by defining the reference type for associating an input data set to a learning model and defining a reference type for associating an input data set used when generating the media data to the media data, the associated entity can be designated. Accordingly, if each item is associated in a similar manner, the location where the association information is described is not particularly limited.

Next, a definition for associating and storing information relating to generation and modification by AI for any of the media items stored in the HEIF file 200 using information relating to AI processing configured according to such definitions will be described. In a case where the media data generated or modified by AI is a still image, the media data is configured of data obtained by encoding the still image and an image item for identifying this. Also, an item ID for a still image item generated or modified by AI, an item ID indicating learning model information used in generating or modifying this, and an item ID indicating the data input when generating or modifying are designated and grouped in an entity of AIGenerationInformationEntityGroupBox. Accordingly, by grouping the learning model, the data input to the learning model, and the image data generated or modification as a result of input of the data to the learning model, the information used in the generation or modification can be identified as a group.

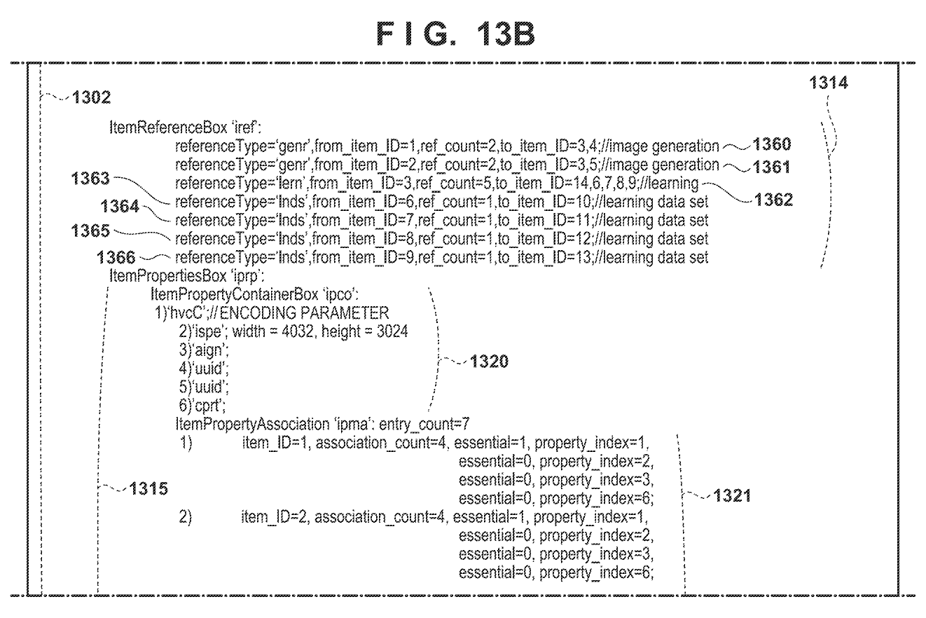

Since items indicating the encoded data 241 to 242 of the image, the learning model data 243, and the inference input data 244 to 245 are grouped in the following data of the box 203, the storage apparatus 100 according to the present embodiment can (associated in a group and) identify the information of when the still image was generated or modified as a group. By associating the AIGeneratedInformationProperty with a group ID indicating this group or an item ID indicating the generated or modified still image, the information of when grouping was performed can be identified as a property (associated in the property). By associating the CopyrightProperty with a group ID indicating this group or an item ID indicating the generated or modified still image, the copyright information of an item included in a group designate by a group ID or an item designated by an item ID can be designated. Also, since the model generation background of the learning model designated as an entity in the AIGenerationInformationEntityGroupBox can be identified, the storage apparatus 100 according to the present embodiment designates and groups the item ID of the learning model information and the item ID for identifying the learning algorithm information and training data set used when training the learning model in an entity of the DeepLearningInformationEntityGroupBox. In this manner, the training data set and the learning algorithm used to generate the learning model can be identified in association with the learning model as a group. Since items indicating the learning model data 243, the learning algorithm data 246, and the training data 247 to 248 are grouped in the following data of the box 203, the storage apparatus 100 according to the present embodiment can identify the information of when the learning model was generated as a group. By associating the CopyrightProperty with a group ID indicating this group, an item ID indicating the learning algorithm data, or an item ID indicating the training data, the copyright information of an item included in a group designate by a group ID or an item designated by an item ID can be designated. An example of an output file of a file output by the storage apparatus 100 according to the present embodiment will now be described with reference to FIG. 12A-C. Note that an image file according to the present embodiment is configured so that the generation background of an image generated by AI via two Entity Groups, the AI Generation Information Entity Group and the Deep Learning Information Entity Group, is stored in a file in an identifiable manner by referencing the file data structure. Also, the storage apparatus 100 according to the present embodiment can generate a learning model by performing training using images and text information relating to the images as training data using the present image file. In a case where text information is input to the learning model and an image is generated, the text information is stored in a file together with the generated image (associated and as information of when the image is generated). This can be used in a case where information relating to the learning model called an image generator AI that outputs two-dimensional images with media data such as text information as input data is stored in a file together with the output image from the learning model, a representative example being Stable Diffusion. In the example of FIG. 12C, as indicated in description 1204 corresponding to the “mdat” box 203, HEVC encoded data (HEVC Image Data) indicated by descriptions 1230 to 1231 corresponding to the encoded data 241 to 242 are stored. The description 1230 indicates an image generated by AI, and the description 1231 indicates a thumbnail image of the image generated by AI. Also, in the example of FIG. 12C, a generator data block indicated by description 1232 corresponding to the learning model data 243 is stored as data of the learning model based on machine learning. Also, text item data (plain text item Data) indicated by description 1233 corresponding to the inference input data 244 to 245 is stored as input text data input to the learning model when generating an image. Furthermore, execution program data indicated by description 1236 corresponding to the learning algorithm data 246 is stored as execution program data of the learning algorithm. Also, HEVC encoded data (HEVC Image Data) indicated by description 1234 corresponding to the training data 247 to 248 is stored as an image used as training data, and text item data indicated by description 1235 is stored as text description data used as training data. Note that the Exif data block 249 is not stored in the present file.

Description 1201 corresponds to the “ftyp” box 201. In the description 1201, “mif1” is stored as a type value major-brand of a brand definition compliant with a HEIF file, and “heic” is stored as a type value compatible-brands of a brand definition with compatibility.

Description 1202 corresponds to an “etyp” box not illustrated in FIG. 2. In the description 1202, “unif” is stored as a type value compatible-brands of an extension brand definition compliant with a HEIF file. This indicates that the ID value at the file level is a uniquely identifiable value.

Next, in description 1203 corresponding to the “meta” box 202, various types of information of metadata describing untimed data stored in an output file example are indicated. Description 1210 corresponds to the hdlr box 211, and the handler type of the MetaDataBox (meta) designated by the description 1210 is “pict”. Description 1211 corresponds to the “pitm” box 212. In the description 1211, 1 is stored as the item_ID, and an ID of an image to be displayed is designated as a first priority image.

Description 1212 corresponds to the “iinf” box 214. The description 1212 indicates the item information (item_ID) and the item type (item_type) for each item. Each item is identifiable by an item_ID, and the item_ID indicates what type of item is the item identified by the item_ID. In the example of FIG. 12A, since ten items are stored in the description 1212, the entry_count is 10, and ten types of information and the item ID and item type for each item are designated in the description 1212.

In the illustrated image file, the first piece of information indicated in description 1240 corresponds to an HEVC encoded image item of type hvc1, and the item is an item indicating an image generated by AI. Also, the fifth piece of information indicated in description 1244 corresponds to an HEVC encoded image item of item type hvc1, which is a thumbnail image. Also, the sixth and seventh piece of information indicated in description 1245 and description 1246 correspond to an HEVC encoded image item of item type hvc1, which are training data set images. Also, the second piece of information indicated by description 1241 corresponds to a deductive Information item of type uri, and the item is an item indicating the learning model for generating the image with text information as the input data. The third and fourth piece of information indicated by description 1242 and description 1243 correspond to text items of type mime, and the items are items indicating text information input to the learning model when generating the image. The eighth and ninth piece of information indicated by description 1247 and description 1248 correspond to text items of type mime, and the items are items indicating text information forming a training data set corresponding to the training data set image. The tenth piece of information indicated by description 1249 corresponds to an item indicating learning algorithm information of type uri.

Description 1213 corresponds to the iloc box 213. In the description 1213, the storage location in the HEIF file of each item and data size information are designated. For example, in the example of FIG. 12A, the description 1213 indicates that, for the encoded image item with an item_ID of 1, the offset in the file is stored at location 01 and the size of the item is L1 byte. According to such a description, the location of each piece of data in the mdatBox is identified.

Description 1214 corresponds to the iref box 215 and indicates the reference relationship (association) between each item. The item reference indicated in description 1250 is designated by thmb indicating a thumbnail relationship as the reference type. In the example of FIG. 12A, the description 1214 indicates that the HEVC encoded image item of item_ID 1 designated in to_item_ID is referenced from the HEVC encoded image item of item_ID 5 designated in from_item_ID. Accordingly, the HEVC encoded image item of item_ID 5 is indicated to be a thumbnail image of the HEVC encoded image item of item_ID 1. The item reference indicated in description 1251 and description 1252 are designated as cdsc for the reference type indicating the content description relationship. In the example of FIG. 12A, the description 1251 indicates that the HEVC encoded image item of item_ID 6 designated in to_item_ID is referenced from the text information item of item_ID 8 designated in from_item_ID. Accordingly, the text information item of item_ID 8 is indicated to be describing content information of the HEVC encoded image item of item_ID 6. In a similar manner, the description 1252 indicates that the HEVC encoded image item of item_ID 7 designated in to_item_ID is referenced from the text information item of item_ID 9 designated in from_item_ID. Accordingly, the text information item of item_ID 9 is indicated to be describing content information of the HEVC encoded image item of item_ID 7.

Description 1215 and description 1216 corresponding to the grpl box 218, and these designate the entity group. In the HEIF file according to the present embodiment, two entity groups, AI Generation Information Entity Group and Deep Learning Information Entity Group, are designated.

The description 1215 corresponds to the aigi box 232, and the description 1216 corresponds to the dlif box 231. The description 1215 designates 100 for the group_id; item_id 1, 2, 3, and 4 for the entity_id; and the item_id 1 described at the top here is identified as an item (image item in the present file example) indicating media data generated or modified by AI (learning model and input data). Also, item_id 2 described second is identified as an item indicating learning model data of when generated or modified by AI, and item_id 3 and 4 described third and onward are identified as an item indicating input data of when generated or modified by AI. The description 1216 designates 101 for the group_id; item_id 2, 10, 6, and 7 for the entity_id; and the item_id 2 described at the top here is identified as an item indicating learning model data generated as a result of learning based on machine learning. Also, item_id 10 described second is identified as an item indicating execution program data of a learning algorithm for generating a learning model, and item_id 6 and 7 described third and onward are identified as an item indicating data forming a training data set. Note that item_id 6 and 7, as indicated in the description 1251 and the description 1252, are further associated with item data indicating text information as the training data set and are identified together as training data.

Description 1217 corresponds to the iprp box 216 and includes description 1220 corresponding to the ipco box 221 and description 1221 corresponding to the ipma box 222. The description 1220 lists, as entry data, the property information that can be used in each item or entity group. As illustrated, the description 1220 includes a first and second entry indicating an encoded parameter and a third and fourth entry indicating the display pixel size of the item. Also, the description 1220 includes a fifth entry indicating that the media data was generated by AI, a sixth and seventh entry providing detailed parameters of the learning model and the learning algorithm execution program, and an eighth entry indicating a copyright statement.

The property information listed in the description 1220 is associated with each item or entity group stored in the HEIF file in the entry data of the description 1221 corresponding to the ipma box 222. In the example of FIG. 12B, “hvcC” (property_index of 1) is associated with the image items with an item_ID of 1 indicating an encoded parameter. In a similar manner, “ispe” (property_index of 3) is associated with the image items with an item_ID of 1 indicating that the image size is 4032 pixels × 3024 pixels. Also, “aign” (property_index of 5) and “cprt” (property_index of 8) are associated with image items with an item_ID of 1 indicating media data generated or modified by AI and information of a copyright statement. “uuid” (property_index of 6) is associated with the learning model items with an item_ID of 2 indicating a detailed parameter unique to the learning model or the like. “ispe” (property_index of 4) is associated with the image items with an item_ID of 5 indicating an image with an image size of 768 pixels × 576 pixels. In a similar manner, “hvcC” (property_index of 2) is associated with the image items with an item_ID of 5 indicating an encoded parameter. A common “ispe” (property_index of 3) is associated with the image items with an item_ID of 6 and 7 indicating an image with the same image size of 4032 pixels × 3024 pixels. In a similar manner, a common “hvcC” (property_index of 1) is associated with the image items with an item_ID of 6 and 7 indicating the same encoding parameter. “uuid” (property_index of 7) is associated with the learning algorithm items with an item_ID of 10 indicating a detailed parameter unique to the learning algorithm execution program or the like.

Also, “cprt” is associated with an AI generation information entity group with an item_id (group_id) of 100 indicating a copyright statement.

Note that in items with the item_ID of 3, 4, 8, and 9 and entity groups with the group_id of 101, no item property are associated, and thus the corresponding entry information is not stored in the file.

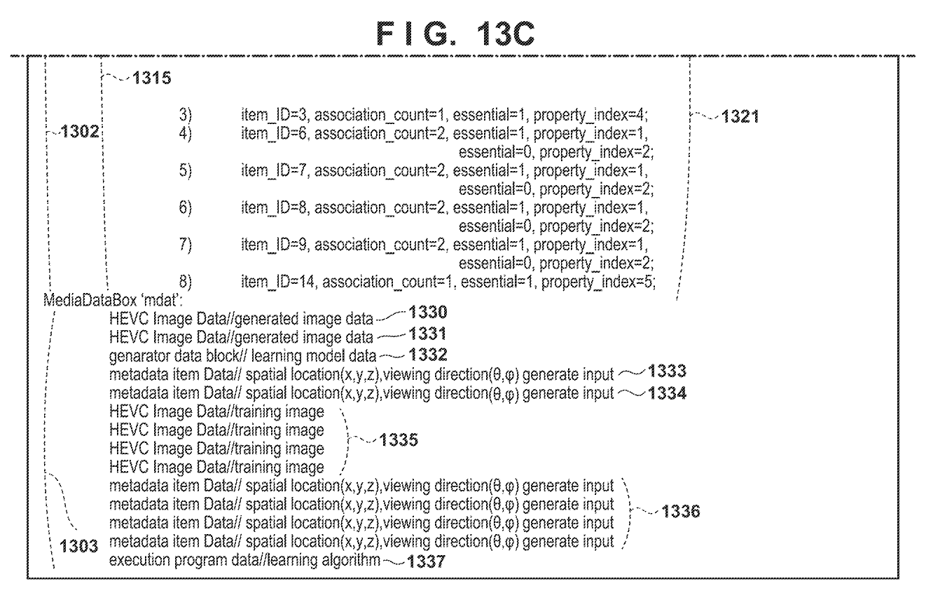

Note that in the example of the present HEIF file, images forming a training data set and text information based on the images are each defined as items. Also, since the association of these pieces of data is performed by irefBox, the training data set is made identifiable. However, for example, the image may be defined as an item, “udes” property specified in ISO/IEC 23008-12 (HEIF) may be stored in ipcoBox for the text information, and association between the image and the text information may be performed in an ipma box so that the training data set is made identifiable. Also, association between these pieces of data may not be performed, each piece of data may be made identifiable so as to be treated as a data set with the entity IDs listed and described in a dlif entity group. Next, another example of an output file of a file output by the storage apparatus 100 according to the present embodiment will be described with reference to FIG. 13A-C. Note that in the present embodiment, the image file has a file data structure in which the generation background of an image generated by AI is stored in the file as identifiable information by defining the type of the item reference and associating an item instead of using a method using the entity groups illustrated in FIG. 12A-C. Also, in the example of the present file, a learning model is generated by performing training using images and metadata relating to camera space coordinates of when the images were captured and viewpoint directions as training data. Also, in the example described here, by inputting metadata indicating virtual viewpoint space coordinates and viewpoint directions into the learning model as input data, an image from a freely chosen viewpoint is generated, and the information of when the image was generated is stored in the file together with the image. The file illustrated in FIG. 12A-C is an example of a file that stores, together with an output image, information of when a two-dimensional image is output from a virtual viewpoint generated using a neural network for reconstructing three-dimensional scenes from a sequence of a plurality of two-dimensional images called NeRF. Note that the image stored as the output result here is an image output using NeRF and obtained by generating image data from volume density and radiance. In the example of FIG. 13C, as indicated in description 1303 corresponding to the “mdat” box 203, HEVC encoded data (HEVC Image Data) indicated by descriptions 1330 to 1331 corresponding to the encoded data 241 to 242 are stored. The description 1330 and the description 1331 indicate images output as images from different virtual viewpoints generated by AI (NeRF). Also, a generator data block indicated by description 1332 corresponding to the learning model data 243 is stored as data of the NeRF learning model (neural network) based on machine learning. Also, metadata item data (metadata item Data) indicated by descriptions 1332 to 1333 corresponding to the inference input data 244 to 245 is stored as input metadata (virtual viewpoint and line-of-sight direction) of when an image is generated. Furthermore, execution program data indicated by description 1337 corresponding to the learning algorithm data 246 is stored as execution program data of the (NeRF) learning algorithm. Also, HEVC encoded data (HEVC Image Data) indicated by description 1335 corresponding to the training data 247 to 248 is stored as (a sequence of two-dimensional) images forming training data, and metadata item data indicated by description 1336 is stored as training data indicating the viewpoint and line-of-sight direction corresponding to the training data images of the description 1335. Note that the Exif data block 249 is not stored in the present file.

Description 1301 corresponds to the “ftyp” box 201. In the description 1301, “mif1” is stored as a type value major-brand of a brand definition compliant with a HEIF file, and “heic” is stored as a type value compatible-brands of a brand definition with compatibility.

Next, in description 1302 corresponding to the “meta” box 202, various types of information of metadata describing untimed data stored in an output file example are indicated. Description 1310 corresponds to the hdlr box 211, and the handler type of the MetaDataBox (meta) designated by the description 1310 is “pict”. Description 1311 corresponds to the “pitm” box 212. In the description 1311, 1 is stored as the item_ID, and an ID of an image to be displayed is designated as a first priority image.

Description 1312 corresponds to the “iinf” box 214. The description 1312 indicates the item information (item_ID) and the item type (item_type) for each item. Each item is identifiable by an item_ID, and the item_ID indicates what type of item is the item identified by the item_ID. In the example of FIG. 13A, since fourteen items are stored in the description 1312, the entry_count is 14, and fourteen types of information and the item ID and item type for each item are designated in the description 1312.

In the illustrated image file, the first piece of information and the second piece of information corresponding to description 1340 and description 1341 respectively corresponds to an HEVC encoded image item of type hvc1, and these items are items indicating an image generated by AI (neural network). Also, the third piece of information corresponding to description 1342 corresponds to a deductive Information item of type uri, and the item is an item indicating the neural network model based on NeRF. The fourth and fifth piece of information corresponding to description 1343 and description 1344 correspond to metadata items of type meta, and the items are items indicating metadata describing three-dimensional space positions x, y, z and line-of-sight directions θ, φ input into the learning model when generating an image.

Also, the sixth to ninth piece of information corresponding to description 1345 to description 1348 correspond to an HEVC encoded image item of item type hvc1, which are training data set images. The tenth to thirteenth piece of information corresponding to description 1349 to description 1352 correspond to a metadata item of type meta. The items corresponding to the tenth to thirteenth piece of information are items indicating the metadata used as a training data set together with images and here indicate metadata describing the three-dimensional space positions x, y, z and line-of-sight directions θ, φ indicating the camera position and orientation at the time of image capture corresponding to the training data set images.

The fourteenth piece of information corresponding to description 1349 corresponds to an item indicating learning algorithm information of type uri.

Note that the metadata items indicated in the descriptions 1343, 1344 and 1349 to 1352 may describe a property instead of being defined as items and may be associated with the corresponding images as item properties. In such a case, the property data structure can be described using CameraExtrinsicMatrixProperty (cmex) which is being considered for standardization as ISO/IEC 23008-12 (HEIF).

Description 1313 corresponds to the iloc box 213. In the description 1313, the storage location in the HEIF file of each item and data size information are designated. For example, in the example of FIG. 13A, the description 1313 indicates that, for the encoded image item with an item_ID of 1, the offset in the file is stored at location 01 and the size of the item is L1 byte. According to such a description, the location of each piece of data in the mdatBox is identified.

Description 1314 corresponds to the iref box 215 and indicates the reference relationship (association) between each item. The item reference indicated in description 1360 is designated by genr indicating the association of items relating to the generation or modification by AI as the reference type. In the example of FIG. 13B, the description 1314 indicates that an item indicating the neural network model based on NeRF of item_ID 3 designated in to_item_ID and a metadata item describing the three-dimensional space positions x, y, z and line-of-sight directions θ, φ of item_ID 4 are referenced from the HEVC encoded image item of item_ID 1 designated in from_item_ID. Accordingly, the HEVC encoded image item of item_ID 1 is indicated to be an AI generated image generated or modified by inputting a metadata item describing the three-dimensional space positions x, y, z and line-of-sight directions θ, φ of item_ID 4 into a neural network model indicated by NeRF of item_ID 3. In a similar manner, the item reference indicated in description 1361 is designated by genr indicating the association of items relating to the generation or modification by AI as the reference type. Also in a similar manner, in the example of FIG. 13B, the description 1361 indicates that an item indicating the neural network model based on NeRF of item_ID 3 designated in to_item_ID and a metadata item describing the three-dimensional space positions x, y, z and line-of-sight directions θ, φ of item_ID 5 are referenced from the HEVC encoded image item of item_ID 2 designated in from_item_ID. Accordingly, the HEVC encoded image item of item_ID 2 is indicated to be an AI generated image generated or modified by inputting a metadata item describing the three-dimensional space positions x, y, z and line-of-sight directions θ, φ of item_ID 5 into a neural network model indicated by NeRF of item_ID 3.

The reference type genr is an item reference that allows identification of information similar to the aigi entity group illustrated in FIG. 12A. In the aigi entity group, an item ID indicating generated or modified media data designated as the top entity ID is designated in from_item_ID. Also, in the aigi entity group, an item ID indicating a learning model designated as the second entity ID is designated as the first item ID of to_item_ID. Also, an item ID indicating input data designated in the third and onward entity ID is designated from the second to_item_ID onward. Via such descriptions, generated or modified media data can be associated with the learning model data used when generating or modifying the media data and input data corresponding to the input via the item reference instead of the entity group.

Also, the item reference indicated in description 1362 is designated by lern indicating the association of items relating to the learning model generation by machine learning as the reference type. In the example of FIG. 13B, the description 1362 indicates that the item indicating the execution program data of the learning algorithm and the HEVC encoded image items of item_ID 6, 7, 8, and 9 are referenced from the item indicating the neural network model based on NeRF of item_ID 3 designated in from_item_ID for generating the learning model of item_ID 14 designated in to_item_ID. Accordingly, the item indicating the neural network model based on NeRF of item_ID 3 indicates a learning model generated as a result of training with the HEVC encoded image items of item_ID 6, 7, 8, and 9 as the training data set using the item indicating the execution program data of the learning algorithm for generating the learning model of item_ID 14.

The reference type lern is an item reference that allows identification of information similar to the dlif entity group illustrated in FIG. 12A. In the dlif entity group, an item ID indicating learning model data generated as a result of training via machine learning designated as the top entity ID is designated in from_item_ID. Also, in the dlif entity group, an item indicating execution program data of a learning algorithm for generating the learning model designated in the second entity ID is designated as the first item ID of to_item_ID. Also, an item ID indicating data corresponding to the training data set designated in the third and onward entity ID is designated from the second to_item_ID onward. Via such descriptions, learning model data generated as a result of training by machine learning can be associated with the learning algorithm data used in training the learning model and the training data set via the item reference instead of the entity group.

The item reference indicated in description 1363 and description 1366 are designated as Inds for the reference type indicating the training data set association. In the example of FIG. 13B, the description 1363 indicates that the metadata item of item_ID 10 designated in to_item_ID is referenced from the item indicating the HEVC encoded image item of item_ID 6 designated in from_item_ID. Accordingly, the HEVC encoded image item of item_ID 6 and the metadata item of item_ID 10 indicated that they are associated as training data as a set for performing training. In a similar manner, description 1364, description 1365, and description 1366 indicate that the HEVC encoded image item and the metadata item are associated as training data as a set. Note that in a case where an item property is used in the description instead of a metadata item, this association is described in the ipma box 222.

Description 1315 corresponds to the iprp box 216 and includes description 1320 corresponding to the ipco box 221 and description 1321 corresponding to the ipma box 222. The description 1320 lists, as entry data, the property information that can be used in each item or entity group. As illustrated, the description 1320 includes a first entry indicating an encoded parameter and a second entry indicating the display pixel size of the item. Also, the description 1320 includes a third entry indicating that the media data was generated by AI, a fourth and fifth entry providing detailed parameters of the learning model and the learning algorithm execution program, and a sixth entry indicating a copyright statement. The property information listed in the description 1320 is associated with each item or entity group stored in the HEIF file in the entry data of the description 1321 corresponding to the ipma box 222. As in FIG. 12A-C, in the example of FIG. 12A-C also, the association between items and properties are described.

Note that the obtaining all of the data described in the example of the present HEIF file as data to be stored in the file is not required. For example, for a portion or all of the data, the metadata used when obtaining data from an external apparatus may be included in the file.

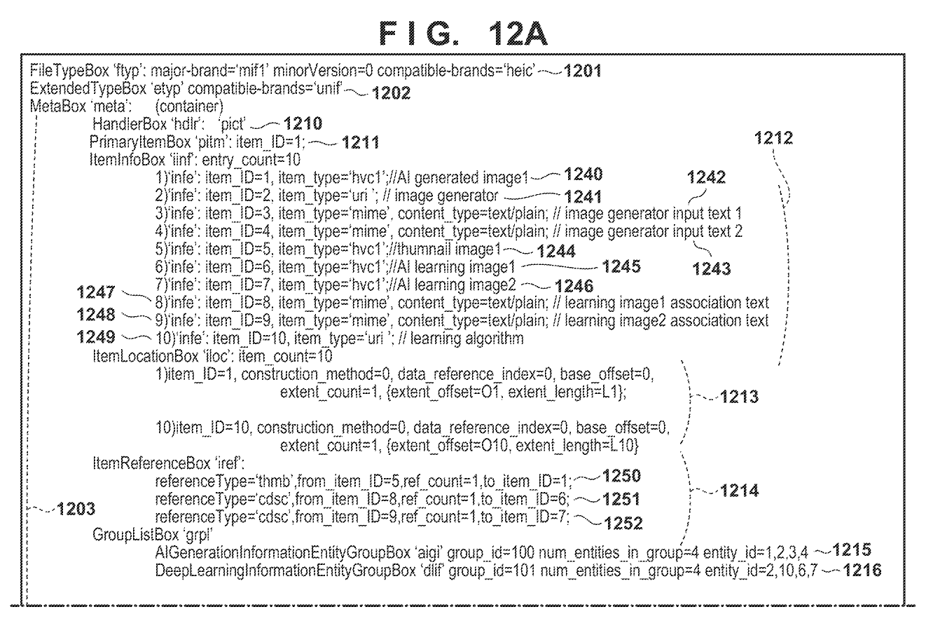

Next, generation processing for generating a media data with a storable file structure in which the content being generated or modified by AI and the conditions of when generated or modified are associated with the media data will be described with reference to the flowchart of FIG. 8.

Note that the processing illustrated in the flowchart of FIG. 8 is processing executed by the CPU 101 executing various types of control processing using a computer program and data read out from the ROM 102 or the non-volatile memory 110 to the RAM 103. Note that the generation processing according to the flowchart of FIG. 8 is started in response to the CPU 101 detecting an instruction relating to image capture being input by the user operating the operation input unit 107 or an instruction relating to AI processing being input. However, the event that triggers the start of the processing according to the flowchart of FIG. 8 is not limited to a specific event. Note that the processing is executed with the data and metadata generated in each step being temporarily stored in an output buffer.

In step S801, the CPU 101 controls the imaging unit 104 or the image processing unit 105 and obtains a data set for training. Note that the training data set obtaining method is not particularly limited, and for example, the training data set may be obtained from the non-volatile memory 110 or obtained from an external apparatus via the communication unit 108. Also, the training data set may be obtained from the imaging unit 104 as a sequence of captured image data.

In step S802, the CPU 101 obtains learning algorithm data from the non-volatile memory 110 or an external apparatus via the communication unit 108. In a case where the obtained learning algorithm data is programming code, the CPU 101 generates executable data.

In step S803, the learning processing unit 114 uses the program execution code of the learning algorithm obtained by the CPU 101 and executes machine learning processing using the training data set obtained by the CPU 101 in step S801. In step S804, the learning processing unit 114 generates learning model data as a result of the training of step S803.

In step S805, the metadata processing unit 112 generates metadata relating to the data set for training. For example, in a case where the data set for training is image data, as the metadata relating to the data set for training, description information such as encoded parameters for encoding the images, size information of the images, item information for identifying these, or the like is generated.

In step S806, the metadata processing unit 112 generates metadata relating to the learning algorithm data. As the metadata relating to the learning algorithm data, for example, description information such as information relating to detailed parameters relating to the learning algorithm, item information for identifying the learning algorithm as an item, or the like is generated. In step S807, the metadata processing unit 112 generates metadata describing information relating to the learning model generated as a result of the training of step S803. As the metadata describing information relating to the learning model, for example, description information such as information relating to detailed parameters relating to the learning model, item information for identifying the learning model data as an item, or the like is generated. Also, in step S807, the metadata processing unit 112 generates metadata (association information) for associating together the learning model data, the learning algorithm data, and the training data set. Note that here, step S807 may be performed by obtaining trained model data, corresponding to the association information, from an external apparatus or the like. Also, in step S807, metadata used for referencing the learning model data including the association information included in an external apparatus may be obtained. Note that in a case where the generation background of the learning model or information relating to copyright is open to the public, such information may be associated as metadata and recorded. In step S808, the CPU 101 obtains input data for the learning model used in executing the inference processing for generating or modifying the media data (by receiving a user operation from the operation input unit 107, for example). Note that the input data obtaining method is not particularly limited, and for example, the input data may be obtained in advance and stored in the non-volatile memory 110 or obtained from an external apparatus via the communication unit 108.

In step S809, the metadata processing unit 112 generates metadata relating to input data. For example, in a case where the input data is image data, as the metadata relating to the input data, description information such as encoded parameters for encoding the images, size information of the images, item information for identifying these, or the like is generated.

In steps S810 to S811, the CPU 101 obtains media data output by the learning model. Here, in step S810, the inference processing unit 113 executes media data generation or modification processing using the learning model and the input data. Next, in step S811, the CPU 101 obtains the media data obtained as a result of step S810. At this time, the metadata processing unit 112 generates and records description information describing the media data obtained in step S811. Note that in a case where the media data obtained here is data that can be compression encoded, the encoding/decoding unit 111 may execute compression encoding processing on the media data.

In step S812, the metadata processing unit 112 generates metadata describing information relating to the learning model used when the media data is output. Here, as the metadata describing information relating to the learning model, association information for the media data of the learning model used when the media data is output or of the input data thereof is generated. Also, the metadata processing unit 112 generates property information indicating (that makes it identifiable) that the media data obtained in step S811 is data generated or modified by AI (the learning model). Also, in a case where the media data obtained in step S811 is data that can designate a copyright statement relating to generated or modified media data (data in which corresponding copyright information exists), the metadata processing unit 112 also generates metadata relating to the copyright statement.

In step S813, the CPU 101 outputs a media file storing the generated metadata and the data and ends the processing of FIG. 8. More specifically, the metadata processing unit 112 configures the final metadata storing the media file on the basis of the information stored in the output buffer. Next, the metadata processing unit 112 combines the information of the “ftyp” box 201 relating to the media file, the information of the “meta” box 202 storing the final metadata, and the information of the “mdat” box 203 storing the media data, AI-related data, and the like. Also, the CPU 101 writes and stores the media file generated by the combining processing from the RAM 103 to the non-volatile memory 110.

In this manner, the storage apparatus 100 according to the present embodiment obtains the data set used in training, algorithm data used in training, learning model data generated as a result of the training and associates them as metadata. Next, the storage apparatus 100 obtains the learning model data and the input data used in the inference processing and associates and makes identifiable the media data generated or modified as a result. Also, the storage apparatus 100 associates information that can identify that the media data has been generated or modified by AI and stores this in a file. Also, a copyright statement relating to the sequence of AI generation processing is also associated as metadata, and stored in a file by the storage apparatus 100. For example, license information for an open-source code may be stored as the copyright statement of the machine learning algorithm information relating to the AI generation processing.

Note that as described above, the media data according to the present embodiment is not limited to image data. For example, as media data, video, audio data, phrases and similar text data, metadata media data, and the like may be included. Also, the sequence of training data set and input data, the learning algorithm data, and the learning model data may be data that is pre-stored in the ROM 102 or the non-volatile memory 110 or may be data received via the communication unit 108, and as long as they can be used in a similar manner by the storage apparatus 100, the obtaining method, data format, and the like are not limited.

Also, the input data input to the learning model when the media data is output is not limited to still images, and video, audio data, phrases and similar text data, metadata obtained from analyzing content, and the like may be used, and as long as the data has a format that can be stored in a media file, the data may be any type. Also, the metadata described in the present embodiment may be as to be stored as Exif tag information. In such a case, it is preferable that the metadata is data specified as an Exif tag, but a manufacturer note or the like may be used to describe that the metadata is Exif tag information.

Note that it is preferable that the media data stored in a file in this manner is recorded together with information that can certify that the data itself is not data falsely or illicitly generated. From this perspective, an authenticity guarantee may be associated with the media data as metadata using a mechanism to guarantee the authenticity as specified in C2PA or the like and the guarantee may be stored in a file.

### Reproduction Processing Flow

Next, the processing executed when reproducing a media file will be described. Here, the media file reproduction processing may be executable by the storage apparatus 100 that generated the media file or may be executable by a reproduction apparatus such as an information processing apparatus (not illustrated) different from the storage apparatus 100. Here, the processor (for example, the CPU 101) such as the CPU of the apparatus executing the media file reproduction processing can read out the metadata of the media file to be processed and reproduce or change the media data stored in the media file.

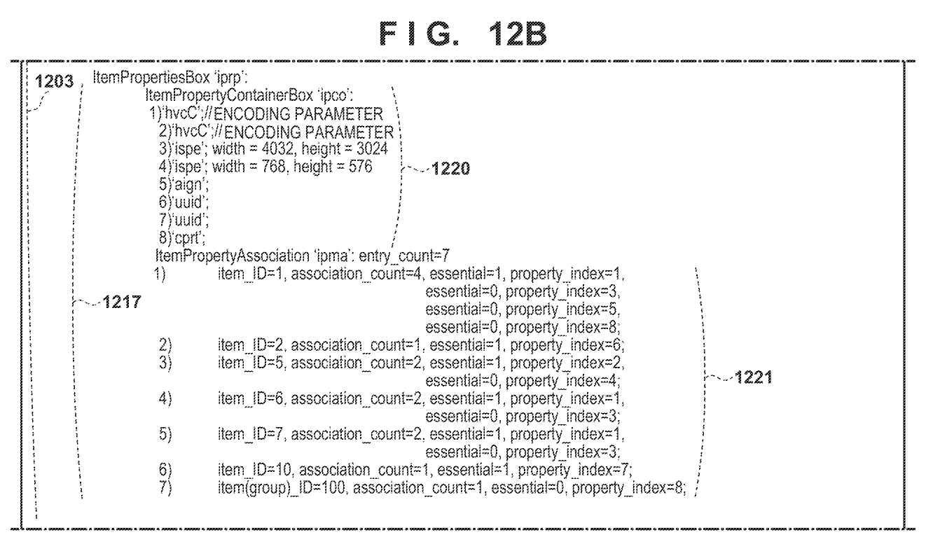

Hereinafter, the reproduction processing of the media file (here, a HEIF file storing a still image as media data) executed by the storage apparatus 100 according to the present embodiment will be described with reference to FIG. 9. The processing illustrated in the flowchart of FIG. 9 is, for example, implemented by the CPU 101 by reading a corresponding processing program stored in the ROM 102 and loading the program on the RAM 103 to cause the blocks to operate. Note that the present reproduction processing described herein is started when a user operation input corresponding to a reproduce instruction for the media file to be processed is detected in a state where the storage apparatus 100 is set in playback mode.

In step S901, the CPU 101 obtains a HEIF file (target file) which was targeted for reproduction by the reproduction instruction. In step S902, the CPU 101 obtains metadata and image data from the HEIF file, and the target file configuration is comprehended by the metadata processing unit 112 analyzing the obtained metadata. In step S903, the CPU 101 identifies a representative item on the basis of the information of the “pitm box 212 of the metadata and causes the encoding/decoding unit 111 to decode encoded data 241 indicating the representative item. Next, the encoding/decoding unit 111 obtains the encoded data corresponding to the metadata relating to the image item designated as the representative item, executes decoding processing, and stores the data obtained via the decoding processing in a buffer on the RAM 103. In the example described below, as the processing target for reproduction, image data designated as a representative item is used. However, in a case where reproduction processing is executed for a plurality of pieces of image data, similar processing can be executed for each piece of image data.

In step S904, the metadata processing unit 112 obtains the metadata associated with the image to be reproduced designated as the representative item stored in the target file. Whether information indicating that the item is media data generated or modified by AI is associated with the metadata associated with the representative item is determined. In a case where it is associated, the processing advances to step S905. In a case where it is not associated, the processing advances to step S908.

In step S905, the metadata processing unit 112 stores information indicating that the image to be reproduced is media data generated or modified by AI in a buffer on the RAM 103.

In step S906, the metadata processing unit 112 determines whether the generation background (by AI) of the representative item can be identified. Here, in a case where learning model data that generated or modified the representative item, input data for the learning model at the time of representative item generation, algorithm information at the time of training the learning model that generated the representative item, or the training data set or a property indicating the generation background of the representative item is associated with the representative item, the metadata processing unit 112 can determine that the generation background of the representative item can be identified. In a case where it is determined that the generation background can be identified, the processing advances to step S907. Otherwise, the processing advances to step S908. In step S907, the metadata processing unit 112 stores the generation background of the representative item in a buffer on the RAM 103, and the processing advances to step S908.

In step S908, the CPU 101 determines whether copyright information is associated with the representative item. In a case where it is determined that it is associated, the processing advances to step S909. Otherwise, the processing advances to step S910. In step S909, the metadata processing unit 112 stores the copyright information in a buffer on the RAM 103, and the processing advances to step S910.

In step S910, the CPU 101 displays an image of the representative item on the display unit 106. Here, the CPU 101 performs display of the image stored in a buffer on the RAM 103 in a configuration in which information indicating that the image to be reproduced is media data generated or modified by AI or information relating to AI generation such as generation background based on AI and copyright information can be referenced. This information may be always displayed together with the image or may be able to be selected to be displayed via turning on or off the display of each item in response to user input on a selection menu. Also, whether or not to display the information may be made selectable as an option. Determining whether or not to display this can be performed in response to a user operation via a UI, for example.

According to the embodiment described above, media data stored in a media file can be identified as media data generated or modified by AI by storing metadata indicating that the media data is data generated or modified by AI. Also, the condition used when the media data is generated using AI and the copyright of the media data generated using AI can also be identified. Also, after changing the training data set for generating an AI learning model and the learning algorithm and re-performing training, media data of the same condition can also be generated. Also, without changing the learning model, the generation condition may be changed and generation of the media data can be re-generated. The background of generation of the media data generated or modified using AI can also be tracked. Also, whether the media data generated or modified using AI constitutes copyright infringement can be identified.

Specifically, whether the media data is media data generated using AI, media data modified using AI, or media data obtained by applying processing using AI without changing the contents can be identified. This can reduce the possibility of infringing on copyright when using the media data stored in the media file. Also, by storing the media data in association with the learning model or input data used when outputting the media data, the algorithm used when generating the learning model, or the training data, the details of the background of outputting the media data can be made identifiable. Also, by storing the details of the background of outputting the media data in association with the media data in this manner, the media data can be output again while changing a portion of the data included in the background. Accordingly, media data can be re-output while changing a portion of the input data for the same learning model, or media data can be re-output using the same input data and different learning models. Also, by changing the learning algorithm or changing the training data and re-generating the learning model, media data can be re-output using the same input data for the re-generated learning model.

Also, by storing the copyright information together with the media data, for media data generated or modified by AI, the copyright of each piece of data used in the generation or modification background can be made identifiable, and the copyright involved with use of such content can be made identifiable. Note that such data is preferably used together with a mechanism that can guarantee that the data has not been falsified. Also, the data is preferably compressed and encoded when stored, but there is no such particular need. The metadata relating to a copyright statement may be stored as information that can be separately referenced without the copyright statement being designated as is.

Also, the various types of information including the copyright information are made able to be referenced by a user when using the media data stored in the media file. Thus, for the end user using the media data, this information can be made easily identifiable. In particular, the background of the generation of the media data generated or modified by AI can be tracked, and in addition, whether the media data generated or modified by AI constitutes copyright infringement can be seamlessly identified.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-176086, filed October 7, 2024, which is hereby incorporated by reference herein in its entirety.

What is claimed is:

1. An information processing method comprising:
obtaining first media data output by a machine learning model;
generating first description information describing the first media data;
generating second description information describing information relating to the machine learning model used when outputting the first media data;
generating association information indicating an association between the first media data, the first description information, and the second description information; and
generating a media file storing the first media data, the first description information, the second description information, and the association information.

2. The information processing method according to claim 1, wherein
the first media data includes a still image, video, audio data, text data, or metadata.

3. The information processing method according to claim 1, further comprising:
obtaining input data input to the machine learning model when outputting the first media data, wherein
the media file is generated to store the input data.

4. The information processing method according to claim 3, wherein
the input data is obtained as second media data input to the machine learning model and metadata for identifying the second media data.

5. The information processing method according to claim 1, wherein
the second description information includes data of a learning algorithm used when training the machine learning model and a training data set used when training the machine learning model.

6. The information processing method according to claim 5, further comprising:
generating third description information indicating that the first media data is media data output by a machine learning model, wherein
the media file is generated to further store the third description information.

7. The information processing method according to claim 1, further comprising:
generating copyright information of the first media data, wherein
the media file is generated to further store the copyright information.

8. The information processing method according to claim 7, wherein
the copyright information includes information indicating that the first media data is copyrighted material, information indicating that copyrighted material is included in training data of the machine learning model, or information indicating that copyrighted material is included in input data input to the machine learning model when outputting the first media data.

9. The information processing method according to claim 1, wherein
the machine learning model is a machine learning model that outputs a two-dimensional image as the first media data based on input data input to the machine learning model when outputting the first media data.

10. The information processing method according to claim 9, wherein
the input data is fourth description information indicating virtual viewpoint space coordinates and a viewpoint direction.

11. The information processing method according to claim 1, wherein
the media file is a media file compliant with an ISOBMFF standard.

12. An information processing method, comprising:
obtaining a media file storing first media data output by a machine learning model, first description information describing the first media data, second description information describing information relating to the machine learning model used when outputting the first media data, and association information indicating an association between the first media data, the first description information, and the second description information; and
executing reproduction processing of the first media data based on the media file.

13. An information processing apparatus comprising:
a first obtaining unit configured to obtain first media data output by a machine learning model;
a first generating unit configured to generate first description information describing the first media data;
a second generating unit configured to generate second description information describing information relating to the machine learning model used when outputting the first media data;
a third generating unit configured to generate association information indicating an association between the first media data, the first description information, and the second description information; and
a fourth generating unit configured to generate a media file storing the first media data, the first description information, the second description information, and the association information.

14. An information processing apparatus comprising:
an obtaining unit configured to obtain a media file storing first media data output by a machine learning model, first description information describing the first media data, second description information describing information relating to the machine learning model used when outputting the first media data, and association information indicating an association between the first media data, the first description information, and the second description information; and
an executing unit configured to execute reproduction processing of the first media data based on the media file.

15. A non-transitory computer-readable storage medium storing a program that, when executed by a computer, causes the computer to perform an information processing method according to claim 1.

16. A non-transitory computer-readable storage medium storing a program that, when executed by a computer, causes the computer to perform an information processing method according to claim 12.
